(19) United States
(12) Patent Application Publication
(10) Pub. No.: US 2002/0010678 A1
(43) Pub. Date: Jan. 24, 2002

(54) Service presenting apparatus, service presenting method, storing medium, network system, charging apparatus, charging method and computer program

(76) Inventor: Takehito Utsunomiya, Kanagawa (JP)

Correspondence Address: ROBIN BLECKER & DALEY, 2ND FLOOR, 330 MADISON AVENUE, NEW YORK, NY, 10017, US

(21) Appl. No.: 09/873,530

(22) Filed: Jun. 4, 2001

(30) Foreign Application Priority Data
Jun. 9, 2000 (JP) 173974/2000

(51) Int. Cl. G06F 17/60

(52) U.S. Cl. 705/40; 705/39

(57) ABSTRACT

When the user acquires service, payment can be performed by utilizing a portable terminal such as a cellular phone which has widely been popularized. When service for pay is acquired from a computer server via a multi-function machine, the multi-function machine requests the user to input phone number of his cellular phone and calls the phone to receive predetermined information regarding the payment. When received, the multi-function machine effects charge processing for the user's service.

### BACKGROUND OF THE INVENTION

1. Field of the Invention

The present invention relates to a service presenting apparatus, a service presenting method, a storing medium, a network system, a charging apparatus, a charging method and computer program and permits payment and collection of charge by utilizing portable terminals such as a cellular phone.

2. Related Background Art

In recent years, service in which various information data can be picked up from information terminals installed at convenience stores has been provided. Heretofore, in many cases, when the information is displayed on a display of the information terminal or is printed out as output, by displaying and printing-out advertisement together, the company presenting such advertisement was burdened with charge for user's utility (charge such as charge for utility of information terminal or information charge) and the user was not requested for such charge.

Recently, many information have had high added value and information charges has been increased accordingly. Thus, only the advertisement fee is insufficient to compensate for the information charge, and the charge for utility is often requested to the user.

However, when the charge for utility is paid, although it is considered that the user pays cash, in such a case, the user must introduce the cash into a machine or must pay the cash at the convenience store, which makes the payment of the charge troublesome under certain conditions.

### SUMMARY OF THE INVENTION

The present invention aims to solve the above-mentioned problem, and an object of the present invention is to permit the user to pay his charge by utilizing a portable terminal such as a cellular phone which has been widely popularized.

A service presenting apparatus according to the present invention for presenting predetermined service in accordance with an operation of the user comprises input means for inputting access information of a portable terminal, access means for effecting access to the portable terminal in accordance with the access information inputted by the input means, receiving means for receiving predetermined information from the portable terminal by effecting the access to the user's portable terminal via the access means, and processing means for effecting predetermined processing in accordance with the predetermined information.

Further, a service presenting method according to the present invention for presenting predetermined service in accordance with an operation of the user comprises an input step for inputting access information of a portable terminal, an access step for effecting access to the portable terminal in accordance with the access information inputted by the input step, a receiving step for receiving predetermined information from the portable terminal by effecting the access to the user's portable terminal via the access step, and a processing step for effecting predetermined processing in accordance with the predetermined information.

Further, a storing medium according to the present invention for storing a computer program capable of carrying out a service presenting method for presenting predetermined service in accordance with an operation of the user comprises a program code for an input step for inputting access information of a portable terminal, a program code for an access step for effecting access to the portable terminal in accordance with the access information inputted by the input step, a program code for a receiving step for receiving predetermined information from the portable terminal by effecting the access to the user's portable terminal via the access step, and a program code for a processing step for effecting predetermined processing in accordance with the predetermined information.

Further, according to the present invention, there is provided a computer program capable of carrying out a service presenting method for presenting predetermined service in accordance with an operation of the user comprises a program code for an input step for inputting access information of a portable terminal, a program code for an access step for effecting access to the portable terminal in accordance with the access information inputted by the input step, a program code for a receiving step for receiving predetermined information from the portable terminal by effecting the access to the user's portable terminal via the access step, and a program code for a processing step for effecting predetermined processing in accordance with the predetermined information.

Further, according to the present invention, there is provided a network system in which a server computer and a terminal is interconnected via a network and which is designed to present predetermined service in accordance with an operation of the user, comprising charge processing means for effecting processing for deducting the charge from his account of a banking organ to which he contracts regarding his portable terminal.

Further, according to the present invention, there is provided a service presenting apparatus for presenting predetermined service in accordance with request of the user, comprising charge processing means for effecting processing for deducting the charge from his account of a banking organ to which he contracts regarding his portable terminal.

Further, according to the present invention, there is provided a charging apparatus for collecting the charge when predetermined service is presented in accordance with request of the user, comprising charge processing means for effecting processing for deducting the charge from his account of a banking organ to which he contracts regarding his portable terminal.

Further, according to the present invention, there is provided a charging method for collecting the charge when predetermined service is presented in accordance with request of the user, comprising a procedure for deducting the charge from his account of a banking organ to which he contracts regarding his portable terminal.

Further, according to the present invention, there is provided a storing medium readable by a computer and adapted to store a program for executing processing for collecting the charge when predetermined service is presented in accordance with request of the user, wherein processing for deducting the charge from his account of a banking organ to which he contracts regarding his portable terminal is carried out.

Further, according to the present invention, there is provided a computer program which is stored in a storing medium readable by a computer and adapted to store a program for executing processing for collecting the charge when predetermined service is presented in accordance with request of the user, wherein processing for deducting the charge from his account of a banking organ to which he contracts regarding his portable terminal is carried out.

In the above-mentioned present invention, when the predetermined service is received by the user, payment can be performed by utilizing the portable terminal.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in an constitute a part of the specification, illustrate embodiments of the invention and, together with the description, serve to explain the principles of the invention.

FIG. 1 is a view showing an entire construction of a network system according to an embodiment of the present invention;

FIG. 2 is a flow chart showing a processing operation of the network system;

FIG. 3 is a view showing an example of a displayed picture plane on a display of an operating portion 108 of a multi-function machine;

FIG. 4 is a view showing another example of a displayed picture plane on the display of the operating portion 108 of the multi-function machine;

FIG. 5 is a view showing a further example of a displayed picture plane on the display of the operating portion 108 of the multi-function machine; and

FIG. 6 is a view for explaining authentication processing.

### DETAILED DESCRIPTION OF THE PREFERRED EMBODIMENTS

Preferred embodiments of the present invention will now be described in detail in accordance with the accompanying drawings.

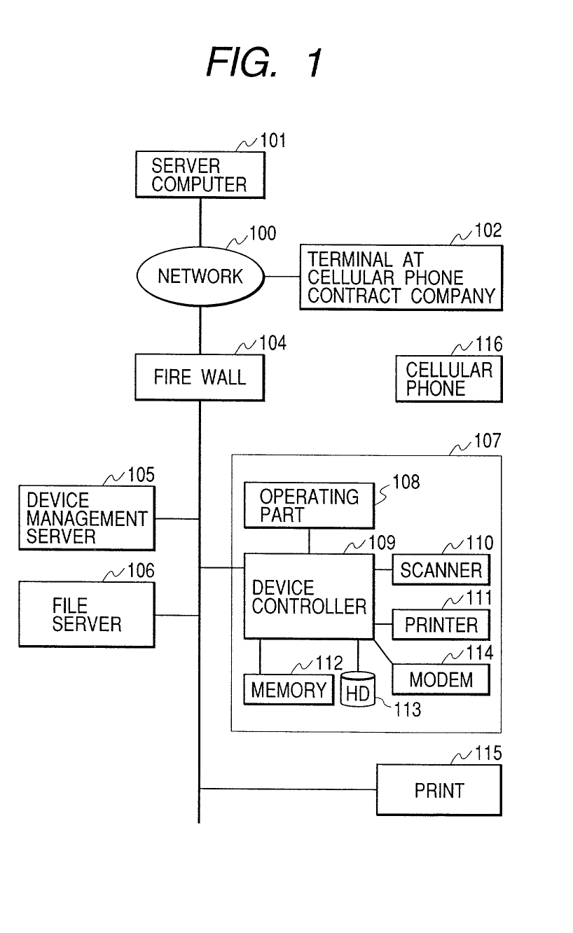

FIG. 1 is a view showing an entire construction of a network system according to an embodiment of the present invention. The system includes a network 100 such as a internet, a server computer 101 connected to the network 100 and adapted to present specific service to the user for pay, and a terminal 103 of a contract company to which the user contracts regarding his portable terminal.

The system further includes a fire wall 104 which serves to connect interior of LAN network shown below the fire wall and to perform security management, a device management server 105 which serves to perform management of devices 106 to 115 connected via the LAN network, user management and data management such as charge information, and a file server 106 which serves to perform advertisement data management and to output the advertisement data to a multi-function machine 107 or a printer 115.

The multi-function machine 107 has functions such as user interface for extracting information and input/output of an image. In the illustrated embodiment, the multi-function machine 107 corresponds to a terminal, a service presenting apparatus and the like defined in the present invention.

The multi-function machine 107 includes an operating portion 108, a device controller 109, an image scanner 110, a printer 111, a memory 112, a hard disk 113, and a modem 114 for connection to a public telephone circuit. The operation portion 108 is manipulated by the user and is constituted by a display and a touch panel, for example. The device controller 109 serves to perform control of input/output of image data between the scanner 110, printer 111, memory 112 and hard disk 113 on the basis of instruction from the operating portion 108. Incidentally, in the illustrated embodiment, a function of charge processing means defined in the present invention is realized by the device controller and the like.

The image scanner 110 serves to input an image in accordance with instruction from the operating portion 108 or a personal computer (not shown). The printer 111 serves to print data from the file server 106 or a personal computer (not shown).

The printer 115 serves to print image data from the file server 106 or a personal computer (not shown) on a recording medium.

The reference numeral 116 denotes a cellular phone possessed by the user and utilizing the multi-function machine 107.

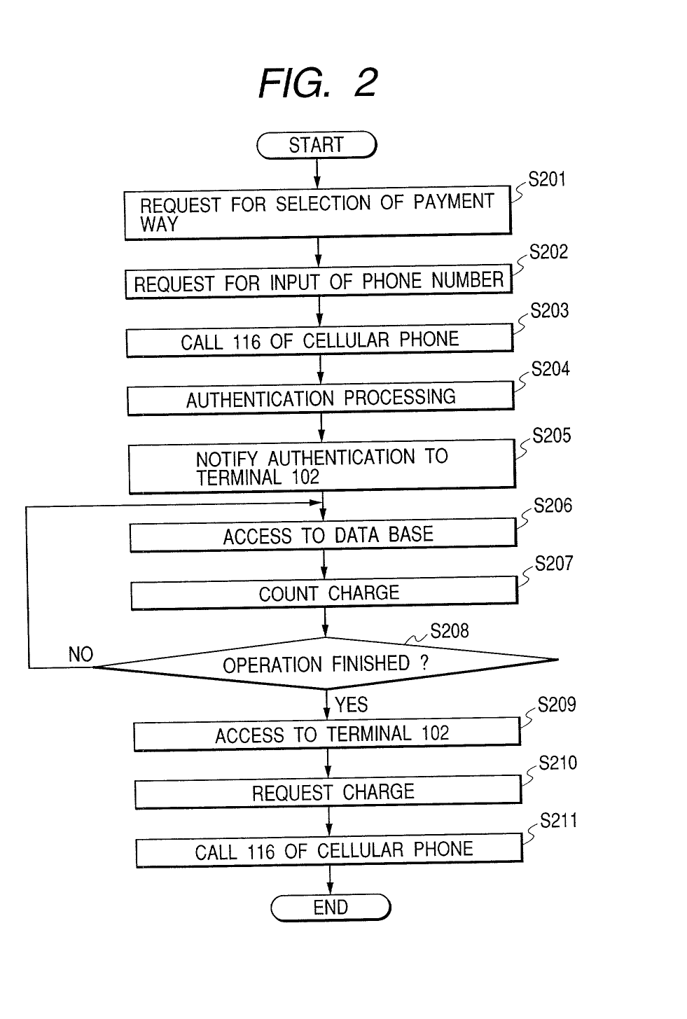

Next, a processing operation of the network system according to the illustrated embodiment will be explained with reference to FIGS. 2 to 6.

FIG. 2 is a flow chart for explaining the processing operation of the multi-function machine 107 in the network system according to the illustrated embodiment.

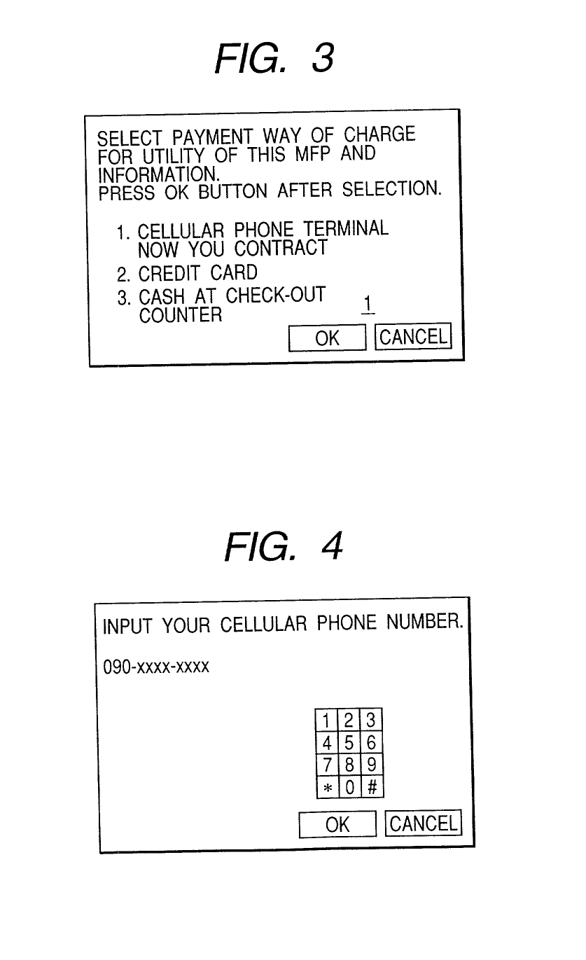

When the user retracts fee-charging information from the server computer 101 via the multi-function machine 107, the multi-function machine 107 requests for selection of payment way of charge for utility (use charge and information charge) via the display of the operating portion 108 (step S201). FIG. 3 shows an example of a displayed picture plane displayed on the display of the operating portion 108 of the multi-function machine 107. The user selects either one of payment ways (“1. payment by utilizing his portable terminal”, “2. payment via credit card” or “3. payment with cash at check-out counter”) by manipulating an OK button or a cancel button.

If the user has the cellular phone 116 and “1. payment by utilizing his portable terminal” is selected, as shown in FIG. 4, input of a telephone number of the cellular phone 116 is requested via the display of the operating portion 108 (step S202). The user inputs his telephone number of the cellular phone 116 by manipulating numeral-key. The telephone number of the cellular phone 116 corresponds to access information defined in the present invention.

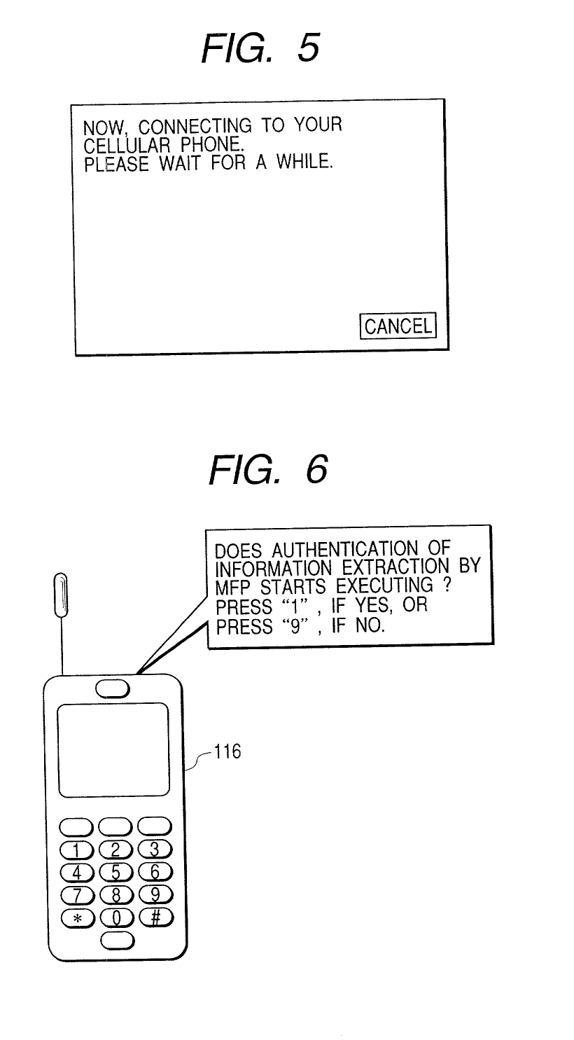

When the telephone number is inputted, the device controller 109 calls the inputted telephone number by using the modem 114 (step S203). In this case, as shown in FIG. 5, the message “connecting to your phone” is displayed on the display of the operating portion 108.

When the user's cellular phone 116 is connected, for example, as shown in FIG. 6, authentication processing regarding deduction of charge for utility from user's account of a banking organ to which he contracts regarding his portable terminal is effected via voice message (step S204). If affirmative, the user depresses a button “1” of his cellular phone, and, if negative, a button “9” is depressed.

When the device controller 109 receives the user's agreement from his cellular phone via the modem 114, the connection to the cellular phone 116 is interrupted, and access to the terminal at the cellular phone contract company is effected via the network 100. Then, the agreement between the user and the contract company regarding the deduction of charge for utility from user's account of the banking organ to which he contracts regarding his portable terminal is notified (step S205).

On the other hand, if “2. payment via credit card” is selected by the user via the operating portion of the multi-function machine, ID number of the user's credit card and card company are inputted via the operating portion of the multi-function machine, and the multi-function machine 107 performs access to the authentication server of the card company inputted by the user via the network 100, thereby effecting similar authentication between the credit company and the multi-function machine 107.

Thereafter, in accordance with the user's manipulation of the operating portion 108, the multi-function machine 107 effects access to desired database (step S206), and, count-up of the charge for utility and information charge is effected whenever access to database for pay is performed (step S207).

If the user's operation is finished (step S208), the multi-function machine 107 effects access to the terminal 102 at the cellular phone (116) contract company via the network 100 (step S209) and requests the counted-up charge (step S210).

When the charge transactions between the cellular phone (116) contract company and the multi-function machine 107 is completed, the device controller 109 calls the user's cellular phone 116 again via the modem 114 to notify the charge for utility (step S211). In this way, the processing is ended.

### Other Embodiments

Other than the authentication processing explained in connection with the step S204 in FIG. 2, the phone company may have an authentication center function for effecting authentication. In this case, since the steps S201 to S203 are the same as the aforementioned steps, explanation thereof will be omitted. When the multi-function machine 107 is connected to the user's phone, the multi-function machine 107 sends to the user's cellular phone data such as the name of the authentication center of the cellular phone company from which the charge for utility can be deducted, and such data is displayed on the display of the cellular phone.

The user selects the authentication center of the cellular phone company to which he contracts among the plurality of authentication centers of the cellular phone companies displayed on the display via the operating portion of the phone and disconnects from the multi-function machine 107.

When the multi-function machine 107 receives the authentication center selected by the user, the multi-function machine 107 effects access to the authentication center via the network.

In this case, the multi-function machine 107 sends the user's phone number and unique address of the multi-function machine 107 to the authentication center.

When the data is received from the multi-function machine 107, the authentication center of the cellular phone company calls the user's phone number included in the received information, thereby effecting the authentication processing regarding deduction of charge for utility from user's account of a banking organ to which he contracts regarding his portable terminal via voice message, for example, as shown in FIG. 6. If affirmative, the user depresses a button “1” of his cellular phone, and, if negative, a button “9” is depressed.

If the user's agreement is obtained, access to the multi-function machine 107 is effected via the network 100. The device controller of the multi-function machine 107 receives, via the modem 114 from the authentication center of the cellular phone company, notice of authentication between the user and the phone company regarding the deduction of charge for utility from user's account of the banking organ to which he contracts regarding his cellular phone. Thereafter, since steps are the same as the steps S206 and so on in FIG. 2, explanation thereof will be omitted.

Other than the above, other organ such as a bank may perform authentication.

Further, in the illustrated embodiment, while an example that the flow chart shown in FIG. 2 is executed by the multi-function machine 107 was explained, such flow chart may be executed by an combination of the multi-function machine and other device such as the device management server 105.

A technique in which a software program code for realizing the function according to the illustrated embodiment is supplied to a computer (CPU or MPU) of an apparatus or a system to which various devices according to the illustrated embodiment and such various devices are operated in accordance with the program stored in the computer of the apparatus or the system in order to realize the function according to the illustrated embodiment is also included in the present invention.

In this case, since the function according to the illustrated embodiment is realized by the software program code itself, the software program code itself and means for supplying the software program code to the computer (for example, storing medium for storing the program code) constitute the present invention. The storing medium for storing the program code may be, for example, a floppy disk, a hard disk, an optical disk, a photomagnetic disk, CD-ROM, a magnetic tape, a non-volatile memory card, ROM or the like.

Further, also when not only the function according to the illustrated embodiment is realized by executing the program code supplied to the computer, but also the function according to the illustrated embodiment is realized by cooperating the program code with OS (operating system) running on the computer or other application, such program code is included in an embodiment of the present invention.

Further, a technique, in which, after the supplied program code is stored in a memory of a function expansion board of the computer or of a function expansion unit connected to the computer, the actual processing is performed partially or totally by a CPU of the function expansion board or the function expansion unit, thereby realizing the function according to the illustrated embodiment is also included in the present invention.

Incidentally, it should be noted that configurations and constructions of various elements shown in the illustrated embodiment are merely example and do not limit the technical range of the present invention. That is to say, the present invention can be embodied in various ways without departing from the scope of the invention.

As mentioned above, according to the present invention, when the user acquires predetermined service, the charge can be paid by utilizing the user's portable terminal such as the cellular phone. Nowadays, the portable terminals such as the cellular phones have widely been popularized, and, in almost all cases, since the user has the cellular phone by himself, for example, so long as the payment using the portable terminal according to the present invention is permitted without cash payment at the convenience store, the user can acquire any service easily and conveniently.

What is claimed is:

1. A service presenting apparatus for presenting predetermined service in accordance with an operation of the user, comprising:
input means for inputting access information of a portable terminal;
access means for effecting access to said portable terminal in accordance with the access information inputted by said input means;
receiving means for receiving predetermined information from said portable terminal by effecting the access to the user's portable terminal via said access means; and
processing means for effecting predetermined processing in accordance with the predetermined information.

2. A service presenting apparatus according to claim 1, wherein said predetermined service is input/output of an image.

3. A service presenting apparatus according to claim 1, wherein said predetermined processing is charge processing.

4. A service presenting apparatus according to claim 1, wherein said predetermined information is authentication regarding payment for the predetermined service.

5. A service presenting apparatus according to claim 4, wherein the authentication regarding payment for the predetermined service is authentication regarding deduction of payment for said predetermined service from user's account of a banking organ to which he contracts regarding his portable terminal.

6. A service presenting method for presenting predetermined service in accordance with an operation of the user, comprising:
an input step for inputting access information of a portable terminal;
an access step for effecting access to said portable terminal in accordance with the access information inputted by said input step;
a receiving step for receiving predetermined information from said portable terminal by effecting the access to the user's portable terminal via said access step; and
a processing step for effecting predetermined processing in accordance with the predetermined information.

7. A service presenting method according to claim 6, wherein said predetermined service is input/output of an image.

8. A service presenting method according to claim 6, wherein said predetermined processing is charge processing.

9. A service presenting method according to claim 6, wherein said predetermined information is authentication regarding payment for the predetermined service.

10. A service presenting method according to claim 9, wherein the authentication regarding payment for the predetermined service is authentication regarding deduction of payment for said predetermined service from user's account of a banking organ to which he contracts regarding his portable terminal.

11. A storing medium for storing a computer program capable of carrying out a service presenting method for presenting predetermined service in accordance with an operation of the user, comprising:
a program code for an input step for inputting access information of a portable terminal;
a program code for an access step for effecting access to said portable terminal in accordance with the access information inputted by said input step;
a program code for a receiving step for receiving predetermined information from said portable terminal by effecting the access to the user's portable terminal via said access step; and
a program code for a processing step for effecting predetermined processing in accordance with the predetermined information.

12. A computer program capable of carrying out a service presenting method for presenting predetermined service in accordance with an operation of the user, comprising:
a program code for an input step for inputting access information of a portable terminal;
a program code for an access step for effecting access to said portable terminal in accordance with the access information inputted by said input step;
a program code for a receiving step for receiving predetermined information from said portable terminal by effecting the access to the user'portable terminal via said access step; and
a program code for a processing step for effecting predetermined processing in accordance with said predetermined information.

13. A network system in which a server computer and a terminal is interconnected via a network and which is designed to present predetermined service in accordance with an operation of the user, comprising:
charge processing means for effecting processing for deducting the charge from user's account of a banking organ to which he contracts regarding his portable terminal.

14. A network system according to claim 13, wherein said charge processing means effects,
processing for requesting input of access information to the user's portable terminal via said terminal;
processing for effecting access to said user's portable terminal via in accordance with the access information; and
processing for effecting authentication regarding deduction of charge from user's account of a banking organ to which he contracts regarding his portable terminal, by effecting the access to said user's portable terminal.

15. A network system according to claim 14, wherein a terminal of a contract company to which he contracts regarding his portable terminal is connected to said network, and
further comprising notifying means for notifying the authentication to said terminal of the contract company.

16. A network system according to claim 13, wherein said portable terminal is a cellular phone.

17. A network system according to claim 13, wherein said predetermined service is information presenting service for acquiring information from said server computer.

18. A network system according to claim 13, wherein said terminal has print means for printing out the information acquired from said server computer.

19. A network system according to claim 13, wherein the network system is connected to an external device via said network, and
said charge processing means receives, from said external device, the authentication regarding deduction of charge from user's account of the banking organ to which he contracts regarding his portable terminal effected by said external device.

20. A network system according to claim 13, wherein selection can be made between a system in which the charge is deducted from the user's account of the banking organ to which he contracts regarding his portable terminal and other system.

21. A service presenting apparatus for presenting predetermined service in accordance with request of the user, comprising:
charge processing means for effecting processing for deducting charge from user's account of a banking organ to which he contracts regarding his portable terminal.

22. A service presenting apparatus according to claim 21, wherein said charge processing means effects,
processing for requesting input of access information to the user's portable terminal via said terminal;
processing for effecting access to said user's portable terminal via in accordance with the access information; and
processing for effecting authentication regarding deduction of charge from user's account of a banking organ to which he contracts regarding his portable terminal, by effecting the access to said user's portable terminal.

23. A service presenting apparatus according to claim 21, wherein said portable terminal is a cellular phone.

24. A service presenting apparatus according to claim 21, wherein the predetermined service is information presenting service.

25. A service presenting apparatus according to claim 21, wherein selection can be made between a system in which the charge is deducted from the user's account of the banking organ to which he contracts regarding his portable terminal and other system.

26. A charging apparatus for collecting charge when predetermined service is presented in accordance with request of the user, comprising:
charge processing means for effecting processing for deducting the charge from user's account of a banking organ to which he contracts regarding his portable terminal.

27. A charging method for collecting charge when predetermined service is presented in accordance with request of the user, comprising:
a procedure for deducting the charge from user's account of a banking organ to which he contracts regarding his portable terminal.

28. A storing medium readable by a computer and adapted to store a program for executing processing for collecting charge when predetermined service is presented in accordance with request of the user, wherein:
processing for deducting the charge from user's account of a banking organ to which he contracts regarding his portable terminal is carried out.

29. A computer program which is stored in a storing medium readable by a computer and adapted to store a program for executing processing for collecting charge when predetermined service is presented in accordance with request of the user, wherein:
processing for deducting the charge from user's account of a banking organ to which he contracts regarding his portable terminal is carried out.
